(19) United States
(12) Patent Application Publication
(10) Pub. No.: US 2019/0235473 A1
(43) Pub. Date: Aug. 1, 2019

(54) MACHINING SIMULATION DISPLAY APPARATUS AND MACHINING SIMULATION DISPLAY METHOD

(71) Applicant: Mitsubishi Electric Corporation, Tokyo (JP)

(72) Inventors: Akira MIYATA, Tokyo (JP); Takashi KAMIYA, Tokyo (JP)

(73) Assignee: Mitsubishi Electric Corporation, Tokyo (JP)

(21) Appl. No.: 16/315,480

(22) PCT Filed: Sep. 8, 2016
(86) PCT No.: PCT/JP2016/076437

§ 371 Date: Jan. 4, 2019

(51) Int. Cl. G05B 19/4069; G05B 19/4068; G05B 19/402

(52) U.S. Cl. CPC G05B 19/4069; G05B 2219/35335; G05B 19/402; G05B 19/4068

(57) ABSTRACT

A machining simulation display apparatus displays, on a display screen, an image of a shape of a workpiece and a shape of a tool that machines the workpiece, and includes a display update unit to provide a command to combine, at a change point on a trajectory of the tool, an image of the shape of the tool displayed on the display screen and an image of the shape of the workpiece at a first display update timing at which the image displayed on the display screen is updated or at a second display update timing that is a time point after a lapse of a constant display update interval since the first display update timing, the change point being present between the first display update timing and the second display update timing.

The present invention relates to a machining simulation display apparatus and a machining simulation display method for simulating the machining of a workpiece with a machine tool.

### BACKGROUND

To machine workpieces that are machining targets by using machine tools that are driven by numerical central (NC) devices, a machining simulation is used in which images reproducing a workpiece and a tool attached to the machine tool are displayed on the display screen as an aid to the operations for testing machining programs. Computer aided manufacturing (CAM) systems for creating machining programs or NC devices that execute machining programs to control machine tools often have a function that performs the machining simulation.

By performing the machining simulation, the operator understands, from the displayed animations, the process of machining a workpiece and the process of moving a tool so as to inspect for machining errors, such as excessive cutting or insufficient cutting, and to further inspect whether the tool makes any unintentional movement. Displaying during the machining simulation is updated at certain time intervals or every time a tool movement command has been issued a certain number of times. In recent years, machining of parts with complicated shapes has become common due to improvements in the function and performance of machine tools. This has resulted in a tendency for machining programs to increase in size and to become more complicated. Consequently, the operator cannot follow complicated movements of the tools and thus it becomes difficult for the operator to perform a testing operation. This is becoming more and more of a problem.

To address such a problem, the operation simulation device in Patent literature 1 displays, on a display unit, trajectory figures and arrow figures, which exhibit the characteristics of trajectories of movable objects such as tools, in a superimposed manner so as to make it easier for the operator to follow the trajectories of movable objects.

### CITATION LIST

### Patent Literature

Patent Literature 1: Japanese Patent No. 5426719

### SUMMARY

### Technical Problem

With the method of displaying, on the display unit, figures indicating the trajectories of movable objects and relevant information in a superimposed manner as disclosed in Patent Literature 1, there is, however, a problem in that visibility of a workpiece and a tool, which are what should actually be displayed degrades and this makes it difficult for the tool trajectory to be intuitively understood. It is possible to shorten the display update interval, so as to smoothly display animations and thus make it easier for the operator to follow the tool trajectory. This however causes another problem in that it becomes difficult to determine the display update interval, appropriate for preventing excessive overhead in a display updating process from occurring.

The present invention has been achieved in view of the above and an object of the present invention is to provide s machining simulation display apparatus that enables the tool trajectory during simulation to be easily followed.

### Solution to Problem

In order to solve the above problems; and achieve the object, a machining simulation display apparatus according to an aspect of the present invention is a machining simulation display apparatus that displays, on a display screen, an image of a shape of a workpiece and a shape of a tool that machines the workpiece, the apparatus including: a display update unit to update, at a change point on a trajectory of the tool, an image of the shape of the tool, displayed on the display screen, at a position of the change point and with a posture at the change point, the change point being present between a first display update timing at which the image displayed on the display screen is updated and a second display update timing that is a time point after a lapse of a constant display update interval since the first display update timing.

### Advantageous Effects of Invention

According to the machining simulation display apparatus of the present invention, an effect is obtained where the tool trajectory during simulation can be easily followed. Specifically, with the machining simulation display apparatus of the present invention, displaying is additionally updated only at a change point on the tool trajectory with the display update interval being kept. long; therefore, the problems with the conventional technologies, such as excessive display updating processes caused by finely displaying the progress of the movement along the trajectory and degradation of visibility, can be solved, which means that the tool trajectory can be easily followed.

### BRIEF DESCRIPTION OF DRAWINGS

FIG. 1 is a diagram illustrating a functional configuration of a machining simulation display apparatus according to a first embodiment of the present invention.

FIG. 2 is a diagram illustrating an example of a workpiece to be machined and a machine tool for which a machining program is to be tested.

FIG. 3 is a diagram describing first display update timing, second display update timing, and a display update interval in a control unit illustrated in FIG. 1.

FIG. 4 is a diagram illustrating a workpiece, a tool, and a tool trajectory displayed on a display screen illustrated in FIG. 1.

FIG. 5 is a diagram illustrating examples of an image updated by the machining simulation display apparatus according to the first embodiment of the present invention.

FIG. 6 is a flowchart describing an operation performed by the machining simulation display apparatus according to the first embodiment of the present invention.

FIG. 7 is a diagram illustrating examples of an image updated by a machining simulation display apparatus according to a second embodiment of the present invention.

FIG. 8 is a flowchart describing an operation performed by the machining simulation display apparatus according to the second embodiment of the present invention.

FIG. 9 is a diagram illustrating an exemplary configuration oil hardware implementing the machining simulation display apparatuses according to the first and second embodiments of the present invention.

FIG. 10 is a diagram illustrating another example of change points on the tool trajectory according to the first and second embodiments of the present invention.

### DESCRIPTION OF EMBODIMENTS

A machining simulation display apparatus and a machining simulation display method according to embodiments of the present invention will be described below in detail with reference to the drawings. This invention is not limited to the embodiments.

### First Embodiment

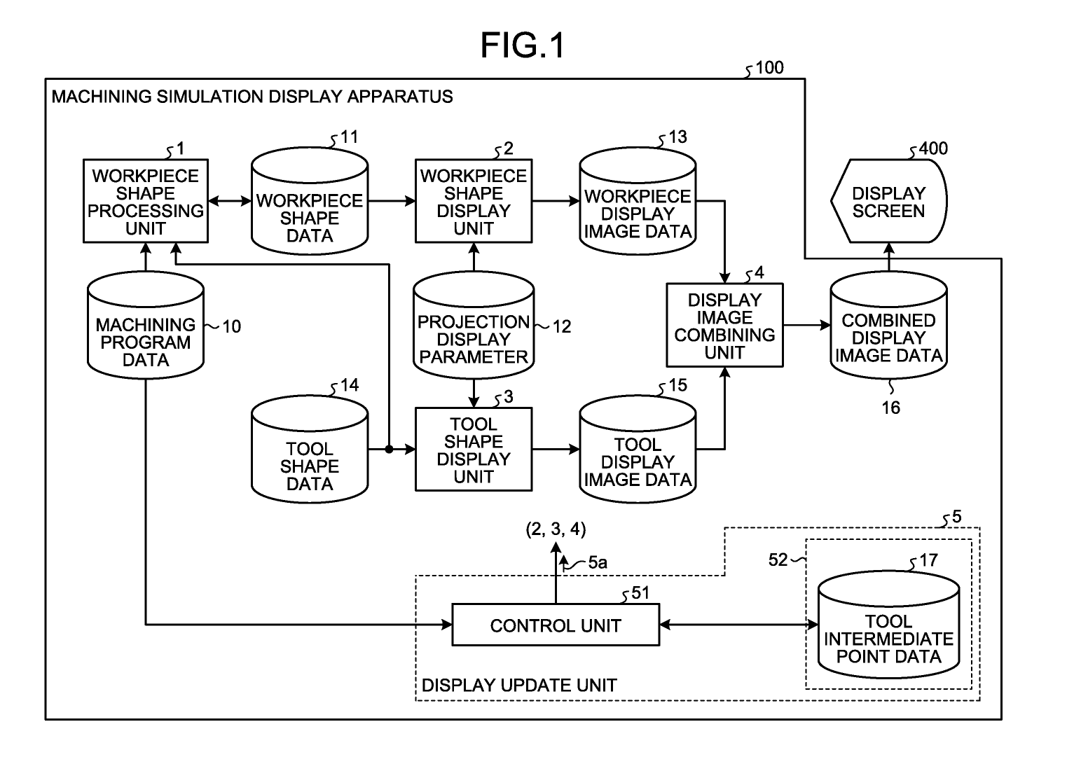

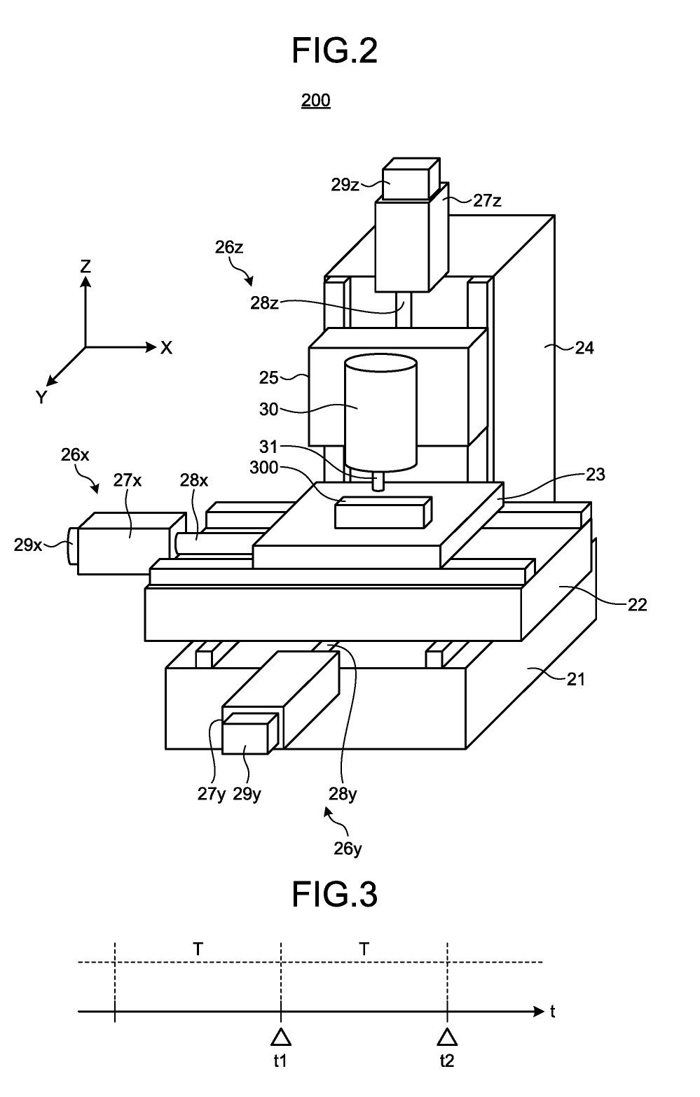

FIG. 1 is a diagram illustrating a functional configuration of a machining simulation display apparatus according to a first embodiment of the present invention. FIG. 2 is a diagram illustrating an example of a workpiece to be machined and a machine tool for which a machining program is to be tested. In the following descriptions, a workpiece and a machine tool for which a machining program is to be tested will be briefly described with reference to FIG. 2 and then the function of a machining simulation display apparatus 100 according to the first embodiment of the present invention will be described in detail with reference to FIG. 1. Hereinafter, the machining simulation display apparatus 100 is simply referred to as “machining simulator 100” in some cases.

FIG. 2 illustrates the appearance of a machine tool 200, which is an example of an orthogonal three-axis vertical machine tool. The machine tool 200 includes a mount 21; a saddle 22 that is placed on the mount 21 and is moved in the y-axis direction; a work table 23 that is placed on the saddle 22; and a column 24 that is fixed to the mount 21 and extends upward from the mount 21. A ram 25 is attached to the column 24 and a workpiece 300, which is to be machined, is placed on the work table 23.

The machine tool 200 illustrated in FIG. 2 further includes an x-axis driving mechanism 26x that is an actuator that is attached to the saddle 22 and moves the work table 23 in the x-axis direction; a y-axis driving mechanism 26y that is an actuator that is attached to the mount 21 and moves the saddle 22 in the y-axis direction; and a x-axis driving mechanism 26z that is an actuator that is attached to the column 24 and moves the ram 25 in the z-axis direction.

The x-axis driving mechanism 26x includes an x-axis motor 27x; a feed shaft 28z. driven by the x-axis motor 27x; and a rotation-angle detector 29x that detects the rotation angle of the feed shaft 23x. The y-axis driving mechanism 26y includes a y-axis motor 27y; a feed shaft 28y driven by the y-axis motor 27y; and a rotation-angle detector 22y that detects the rotation angle of the feed shaft 28y. The x-axis driving mechanism 26z includes a z-axis motor 21z; a feed shaft 28z driven by the x-axis motor 27z; and a rotation-angle detector 29z that detects the rotation angle of the feed shaft 28z. Examples of the machine tool include, other than the orthogonal three-axis vertical machine tool illustrated as an example in FIG. 2, a four-axis machine tool and a five-axis machine tool that further include a rotation shaft for changing the tool posture; however, the present invention can be used for any type of machine tool without being limited to these examples.

The x-axis driving mechanism 26x moves the work table 23, and the y-axis driving mechanism 26y moves the saddle 22 and the x-axis driving mechanism 26x placed on the top of the saddle 22. The z-axis driving mechanism 26 attached to the column 24 moves the ram 25 and a spindle 30, and the workpiece 300 is machined by a tool 31 attached to the tip of the spindle 30. As a result, with the combination of two degrees of freedom in movement of the workpiece 300 in the xy plane and one degree of freedom in movement of the tool 31 in the s-axis direction, the material of the workpiece 300 is removed from its surface at the portion where the tool 31 intersects with the workpiece 300 in the xyz space or three-dimensional space, i.e., with three degrees of freedom. Consequently, a three-dimensional shape is created.

The machining simulator 100 illustrated in FIG. 1 is an apparatus that simulates machining of the workpiece 300 performed by the machine tool 200 illustrated in FIG. 2. The machining simulator 100 includes a workpiece shape processing unit 1 that performs an updating process of workpiece shape data 11 on the basis of the tool movement commands described in machining program data 10 and a workpiece shape display unit 2 that, upon receiving the workpiece shape data 11, performs a projection process in accordance with a projection display parameter 12 and generates and outputs workpiece display image data 13.

The machining program data 10 is data that describes a plurality of tool movement commands that are movement commands for the tool 31 in FIG. 2, which is the subject of the machining simulation. The workpiece shape processing unit 1 simulates machining by moving, on the basis of the tool movement commands described in the machining program data 10, the three-dimensional shape model represented by tool shape data 14 and by sequentially changing the three-dimensional shape model represented by the workpiece shape data 11. Specifically, the workpiece shape processing unit 1 repeats the process of analyzing each of the tool movement commands; calculating the area in which the three-dimensional shape model represented by the workpiece shape data 11 intersects with the three-dimensional swept shape obtained by continuously moving the three-dimensional shape model represented by the tool shape data 14 along a curve according to the movement mode from the start point to the end point of the movement; and updating the workpiece shape data 11 with the data obtained by subtracting the intersection area from the three-dimensional shape model represented by the workpiece shape data 11.

The workpiece shape data 11 is data obtained by simulating, with a three-dimensional shape model, the instantaneous shape of the workpiece 300 from the machining start position to the machining end position. The workpiece display image data 13 is image data for a workpiece obtained by projecting the three-dimensional shape model represented by the workpiece shape data 11 in accordance with the projection display parameter 12. The workpiece display image data 13 is a combination of color data representing brightness and color of pixels and depth data representing the depth information for the projection.

The machining simulator 100 further includes a tool shape display unit 3 that performs, on the basis of the position and posture of the tool at a designated time point during the machining simulation, a projection process or; the three-dimensional shape model represented by the tool, shape data 14 in accordance with the projection display parameter 12 and then outputs tool, display image data 15. The tool shape data 14 is data obtained by simulating the shape of the tool 31 by using a three-dimensional shape model. The tool display image data 25 is a display image obtained by projecting the three-dimensional shape model represented by the tool shape data 14 in accordance with the projection display parameter 12. The tool display image data 15 is a combination of color data representing brightness and color or pixels and depth data representing the depth information for the projection.

The machining simulator 100 further includes a display image combining unit 4 that, on the basis of the workpiece display image data 13 and the tool display image data 15, combines a workpiece shape image and a tool shape image to generate and output combined display image data 16 for displaying, on a display screen 400, the combined image of the workpiece shape image and the tool shape image. The combined display image data 16 is image data obtained by performing a hidden surface elimination process on the workpiece display image data 13 and the tool display image data 15 by using z-buffering. The combined display image data 16 is output to the display screen 400 connected to the machining simulator 100. The display screen 400 displays, on the basis of the combined display image data 16, an image that reproduces the shapes of the workpiece 300 and the tool 31 illustrated in FIG. 2.

The machining simulator 100 further includes a display update unit 5 that updates an image of the shape of the tool displayed on the display screen 400 at a change point on the tool trajectory between the first display update timing at which an image displayed on the display screen 400 is updated and the second display update timing that is a time point after the lapse of a constant display update interval since the first display update timing. The display update unit 5 outputs an execution command 5a to cause the workpiece shape display unit 2, the tool shape display unit 3, and the display image combining unit 4 to update image data at the time when the display update interval has elapsed. Examples of the time when the display update interval has elapsed include a time point when a certain period of time has elapsed and a time point when a certain number of tool movement commands among a plurality of tool movement commands have been executed.

The display update unit 5 includes a control unit 51 and a storage unit 52. The control unit 51 detects the position at which a translational axis or a rotational axis of the machine tool is reversed on the tool trajectory between the first display update timing and the second display update timing during simulation based on the tool movement commands described in the machining program data 10. Hereinafter, the position at which a translational axis or a rotational axis is reversed is in some cases referred to as a change point or an intermediate point. The period of time between the first display update timing and the second display update timing corresponds to the display update interval described above. The feed shafts 28x, 28y, and 23z illustrated in FIG. 2 are translational axes. The rotational, axis is an axis for changing the direction of a tool shaft in a four-axis or five-axis machine tool. The control unit 51 stores, in the storage unit 52 as tool intermediate point data 17, the position and posture of the cool at a position at which a translational axis or a rotational axis is reversed.

When there are one or a plurality of pieces of the tool intermediate point data 17 at intermediate points between the first display update timing and the second display update timing, the control unit 51 controls the tool shape display unit 3 on the basis of the position and posture of the tool at the one or a plurality of intermediate points. Consequently, the tool display image data 15 at the intermediate point(s) is generated in the tool shape display unit 3. The display image combining unit 4 combines a workpiece shape image and a tool shape image at an intermediate point on the basis of the tool display image data 15 and the workpiece display image data 13 at the intermediate point so as to generate the combine display image data 16.

After the tool display image data 15 is generate for all the tool intermediate points, the control unit 51 outputs the execution command 5a at the second display update timing. Consequently, the tool display image data 15 at the second display update timing is generated in the tool shape display unit 3 and the display image combining unit 4 combines a workpiece shape image and a tool shape image at the second display update timing on the basis of the tool display image data 15 arid the workpiece display image data 13 at the second display update timing so as to generate the combined display image data 16.

FIG. 3 is a diagram, describing the first display update timing, the second display update timing, and the display update interval in the control unit illustrated in FIG. 1. As described above, a display update interval T is preset in the control unit 51. In the present embodiment, first display update timing t1 and second display update timing t2 each indicate the time point after the lapse of the display update interval T. The second display update timing t2 represents the latest display update time point in a time sequence, i.e., the present display update time point. The first display update timing t1 represents the previous display update time point, i.e., the display update time point that precedes the second display update timing t2 by the display update interval T.

An operation performed by the machining simulator 100 will be described next.

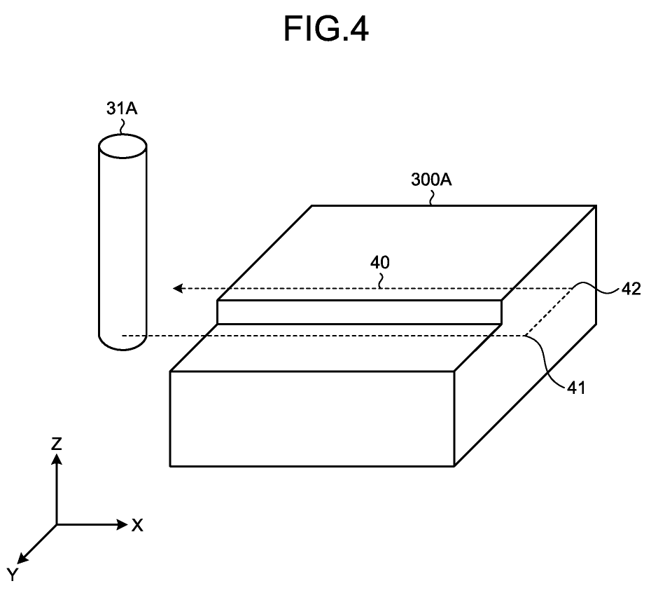

FIG. 4 is a diagram illustrating the workpiece, the tool, and the tool trajectory displayed on the display screen illustrated in FIG. 1. FIG. 4 illustrates a tool shape image 31A and a workpiece shape image 300A updated at the first display update timing t1 illustrated in FIG. 3.

The workpiece shape image 300A is an image displayed on the display screen 400 on the basis of the workpiece display image data 13 generated by the workpiece shape display unit 2 illustrated in FIG. 1 and it is an image obtained by simulating the shape of the workpiece 300 illustrated in FIG. 2. The tool shape image 31A is an image displayed on the display screen 400 on the basis of the tool display image data 15 generated by the tool shape display unit 3 illustrated in FIG. 1 and it is an image obtained by simulating the shape of the tool 31 illustrated in FIG. 2.

A tool trajectory 40 indicated by a dotted line represents the trajectory of the tool shape image 31A during simulation and specifically represents a virtual trajectory of the tool shape image 31A between the first display update timing t1 and the second display update timing t2 illustrated in FIG. 3. A first intermediate point 41 and a second intermediate point 42 on the tool trajectory 40 are positions described above at which a translational axis or a rotational axis is reversed. In the first embodiment of the present invention, the first, intermediate point 41 and the second intermediate point 42 cannot be individually deemed as forming a reversal; however, they form a reversal in a broader sense on the tool trajectory 40 between the first display update timing t1 and the second display update timing t2.

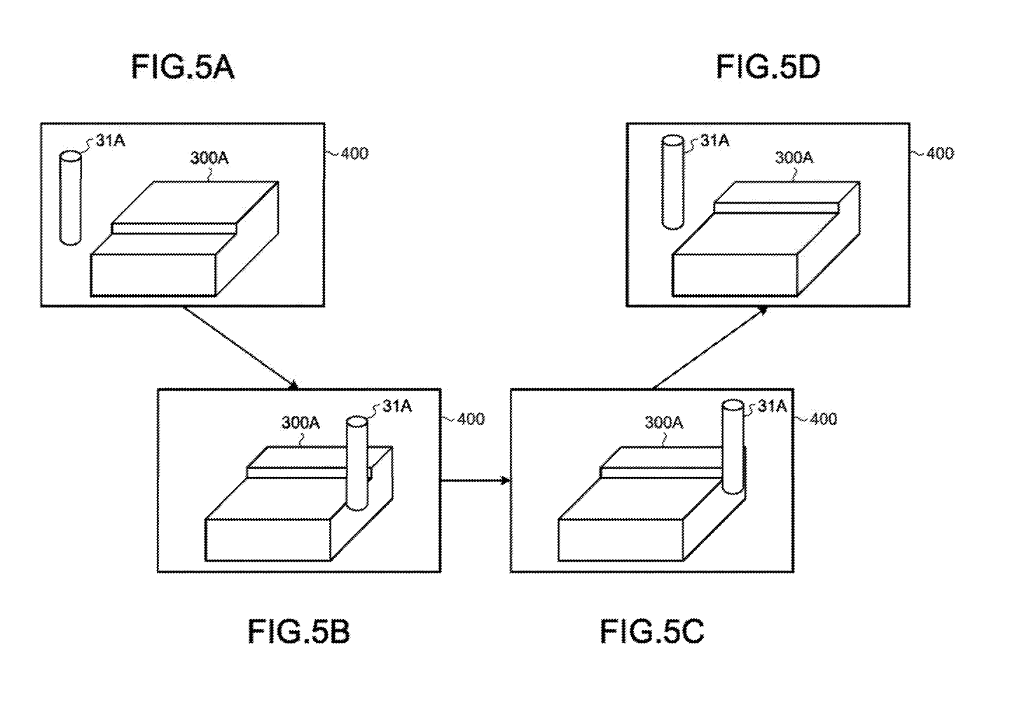

FIG. 5 is a diagram illustrating examples of an image updated by the machining simulation display apparatus according to the first embodiment of the present invention. FIG. 5(a) illustrates an example of how the tool shape image 31A and the workpiece shape image 300A updated at the first display update timing t1 are displayed on the display screen 400. FIG. 5(b) illustrates an example of how the tool shape image 31A and the workpiece shape image 300A updated at the first intermediate point 41 are displayed on the display screen 400. FIG. 5(c) illustrates an example of how the tool shape image 31A and the workpiece shape image 300A updated at the second intermediate point 42 are displayed on the display screen 400. FIG. 5(d) illustrates an example of how the tool shape image 31A and the workpiece shape image 300A updated at the second display update timing t2 are displayed on the display screen 400. The display images in FIGS. 5(b) and (c) correspond to display images at the time when a translational axis or a rotational axis is reversed.

In the machining simulator 100 according to the first embodiment, display images updated at intermediate points are inserted between the display image updated at the first display update timing t1 and the display image updated at the second display update timing t2; therefore, the operator of the machining simulator 100 can visually recognize the tool trajectory between the first display update timing t1 and the second display update timing t2.

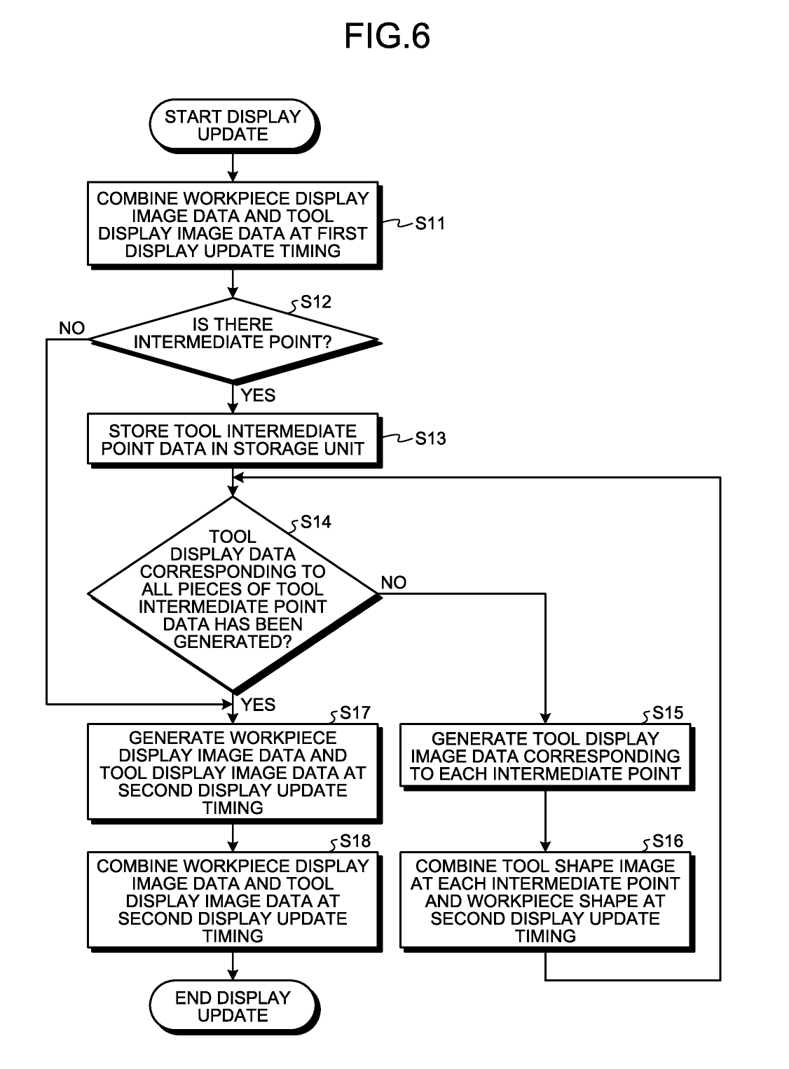

FIG. 6 is a flowchart describing an operation performed by the machining simulation display apparatus according to the first embodiment of the present invention. The machining simulator 100 generates the workpiece display image data 13 and the tool display image data 15 at the first display update timing t1. The machining simulator 100 combines a tool shape image and a workpiece shape image at the first display update timing t1 on the basis of the workpiece display image data 13 and the tool display image data 15 generated at the first display update timing t1 (Step 311). The data for the combined image is sent as the combined display image data 16 to the display screen 400. The image displayed or the display screen 400 at this time point corresponds to the image in FIG. 5(a).

Next, the machining simulator 100 analyzes the tool trajectory between the first display update timing t1 and the second display update timing t2. If there is a position at which a translational axis or a rotational axis is reversed, i.e., an intermediate point (Yes at Step S12), the machining simulator 100 stores, as the tool intermediate point data 17, the position and posture of the tool at a position at which a translational axis or a rotational axis is reversed in the storage unit 52 (Step S13).

At Step S12, if there is no intermediate point (No at Step S12), the machining simulator 100 performs the process at Step S17.

At Step S14, the machining simulator 100 refers to the tool intermediate point data 17 stored in the storage unit 52 and determines whether the tool display image data 15 corresponding to ail the pieces of the tool intermediate point data 17 has been generated.

If the tool, display image data 15 corresponding to any one or more pieces of the tool intermediate point data 17 has not been generated (No at Step S14), the machining simulator 100 generates the tool, display image data 15 corresponding to each intermediate point (Step S15).

The machining simulator 100 combines a tool shape image at each intermediate point and a workpiece shape image at the second display update timing t2 on the basis of the tool display image data 15 at a corresponding intermediate point and the workpiece display image data 13 at the second display update timing t2 (Step S16). The data for the combined images is sent as the combined display image data 16 to the display screen 400. The images displayed on the display screen 400 in this case correspond to the images in FIG. 5(b) and FIG. 5(c).

At Step S14, if the tool display image data 15 corresponding to all the pieces of tool intermediate point data 17 has been generated (Yes at Step 314), the machining simulator 100 generates the workpiece display image data 13 and the tool display image data 15 at the second display update timing t2 (Step S17).

The machining simulator 100 generates, on the basis of the tool display image data 15 and the workpiece display image data 13 at the second display update timing t2, the combined display image data 16 in which the workpiece shape image and the tool shape image at the second display update timing t2 are combined, and it then outputs the combined display image data 16 to the display screen 400 (Step S18). The machining simulator 100 then ends the display update process. The image displayed on the display screen 400 at this time point corresponds to the image in FIG. 5(d).

As described above, with the machining simulator 100 according to the first embodiment, the operator can easily follow the tool trajectory between the first display update timing t1 and the second display update timing t2. Thus, any unintentional machining operation can be easily found. Moreover, with the machining simulator 100 according to the first embodiment., it is possible to minimise additional overhead during the machining simulation display process for the period of time between the first display update timing t1 and the second display update timing 12.

### Second Embodiment

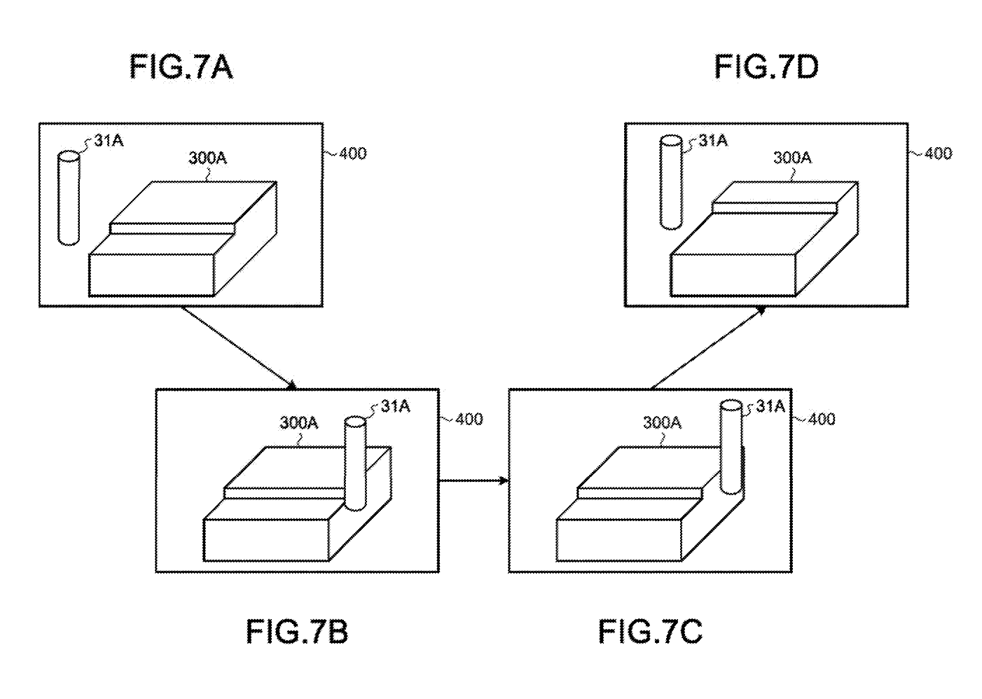

In the first embodiment, a description is given of an exemplary configuration in which the tool display image data 15 generated at an intermediate point is combined with the workpiece display image data 13 generated at the second display update timing t2. Combining the tool display image data 35 generated at an intermediate point with the workpiece display image data 13 generated at the first display update timing t1 can also produce a similar effect to that of the first embodiment. In the second embodiment, a description will be given of an exemplary configuration in which displaying based on the tool display image data 15 at an intermediate point is updated by using the workpiece display image data 13 generated at the first display update timing t1. The machining simulator 100 according to the second embodiment has a functional configuration similar to that of the machining simulator 100 illustrated in FIG. 1, but it performs an operation different from that performed by the machining simulator 100 illustrated in FIG. 1. The operation performed by the machining simulator 100 according to the second embodiment will be described below with reference to FIGS. 7 and 3.

FIG. 7 is a diagram illustrating examples of an image updated by a machining simulation display apparatus according to the second embodiment of the present Invention. FIG. 7(a) illustrates an example of how the tool shape image 31A and the workpiece shape image 300A updated at the first display update timing t1 are displayed on the display screen 400. FIG. 7(b) illustrates an example of how the tool shape image 31A and the workpiece shape image 300A updated at the first intermediate point 41 are displayed on the display screen 400. FIG. 7(c) illustrates an example of how the tool shape image 31A and the workpiece shape image 300A updated at the second intermediate point 42 are displayed on the display screen 400. When the tool shape image 31A is updated at an intermediate point as illustrated in FIG. 7(b) and FIG. 7(c), the machining simulator 100 according to the second embodiment uses the workpiece shape image 300A updated at the first display update timing t1. FIG. 7(d) illustrates an example of how the tool shape image 32A and the workpiece shape image 30GA updated at the second display update timing t2 are displayed on the display screen 400. The display images in FIGS. 7(b) and (c) correspond to display images at the time when a translational axis or a rotational axis is reversed.

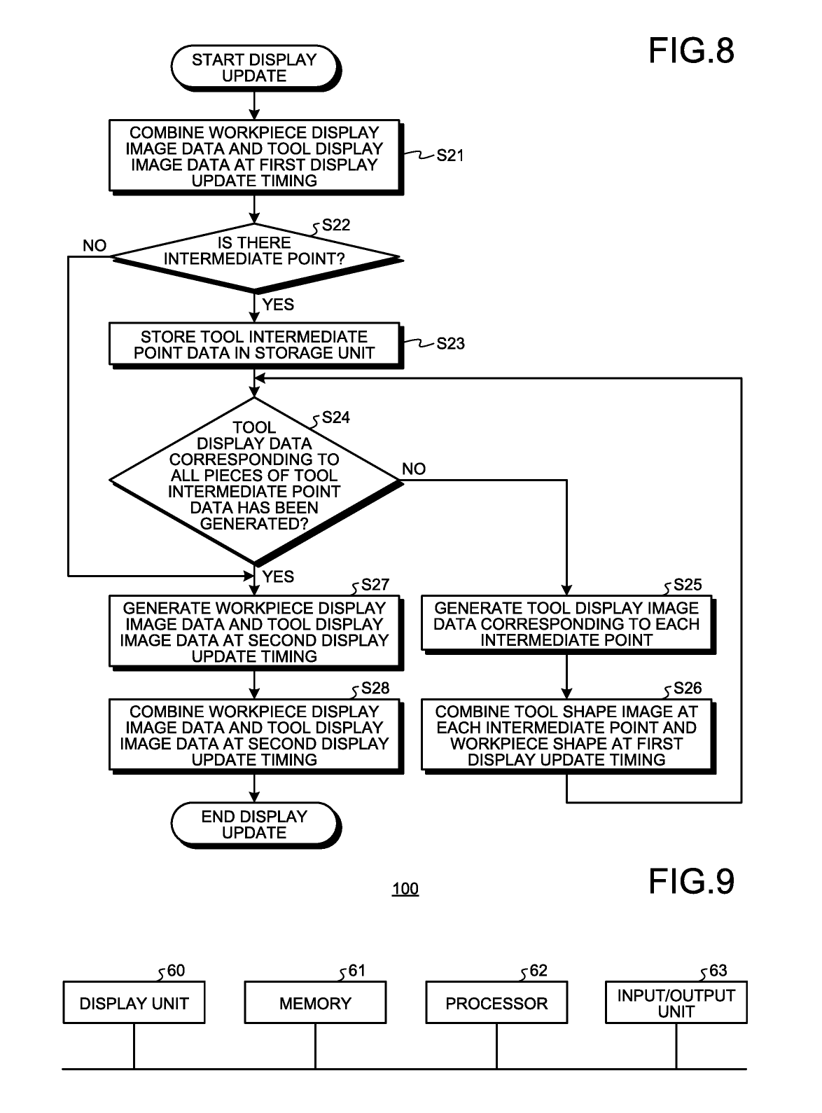

FIG. 3 is a flowchart describing an operation performed by the machining simulation display apparatus according to the second embodiment of the present invention. Step S21 to Step S23 illustrated in FIG. 8 respectively correspond to Step S11 to Step S18 illustrated in FIG. 6. The processing details at Step S26 are however different from those at Step S16 in the flowchart illustrated in FIG. 6. The processing details at steps other than Step S26 ate the same as those at steps other than Step S16 in the first embodiment, and a duplicated description thereof is omitted in the second embodiment.

At Step S16 illustrated in FIG. 6, a tool shape image at each intermediate point and a workpiece shape image at the second display update timing t1 are combined on the basis of the tool display image data 15 at a corresponding intermediate point and the workpiece display image data 13 at the second display update timing t2. In contrast, at Step S26 illustrated in FIG. 8, a tool shape image at each intermediate point and a workpiece shape image at the first display update timing t1 are combined on the basis of the tool display image data 15 at a corresponding intermediate point and the workpiece display image data 13 at the first display update timing t1. The data for the combined images is sent as the combined display image data 16 to the display screen 400. The images displayed on the display screen 400 in this case correspond to the images in FIG. 7(b) and FIG. 7(c).

Because the shape of a workpiece is complicated compared with the shape of a tool, the process of generating a display image of a workpiece consumes more time than the process of generating a display image of a tool. In order to shorten the processing time required for generating a display image of a workpiece, the machining simulator 100 according to the second embodiment is configured to display, on the display screen 400, an image obtained by combining a tool shape image at each intermediate point and a workpiece shape image at the first display update timing t1. With this configuration, the processing time required for generating a display image of a workpiece can be shortened. Moreover, the operator can easily follow the tool trajectory; therefore, an operation for testing a machining program becomes easy.

The display screen 400 illustrated in FIG. 1 may be an image display unit installed in a display device (not illustrated) external to the machining simulator 100 or it may be an image display unit installed in the machining simulator 100.

FIG. 9 is a diagram illustrating an exemplary configuration of hardware implementing the machining simulation display apparatuses according to the first and second embodiments of the present invention. The machining simulation display apparatus 100 includes a display unit 60, a memory 61, a processor 62, and an input/output unit 63. The processor 62 uses received data to cause software to execute calculations and control. The memory 61 stores received data and moreover stores data and software necessary for the processor 62 to execute calculations and control. The machining program data 10 and the tool shape data 14 are input to the input/output unit 63. The input/output unit 63 outputs the combined display image data 16 to the display screen 400. The display unit 60 corresponds to the display screen 400 of the machining simulator 100. The workpiece shape processing unit 1, the workpiece shape display unit 2, the tool shape display unit 3, the display image combining unit 4, and the display update unit 5 illustrated in FIG. 1 are implemented by storing programs for implementing the functions of these components in the memory 61 and by causing the processor 62 to execute the programs.

The machining simulation display method according to the present embodiment is a machining simulation display method performed by a machining simulation display apparatus that displays, on a display screen, an image of the shape of a workpiece and the shape of a tool that machines the workpiece. The machining simulation display method according to the present embodiment includes a change point, determining step of determining a change point on the tool trajectory between the first display update timing at which an image displayed on the display screen is updated and the second display update timing that is a time point after the lapse of a constant display update interval since the first display update timing. The machining simulation display method according to the present, embodiment further includes a first displaying step of combining an image of the shape of the workpiece updated at the first display update timing and an image of the shape of the tool updated at the change point on the tool trajectory and displaying a combined image on the display screen; and a second displaying step of combining an image of the shape of the workpiece updated at the second display update timing and an image of the shape of the tool updated at the second display update timing and displaying a combined image on the display screen. With the machining simulation display method according to the present embodiment, the processing time required for generating a display image of a workpiece can be shortened. Moreover, the operator can easily follow the tool trajectory; therefore, an operation for testing a machining program becomes easy.

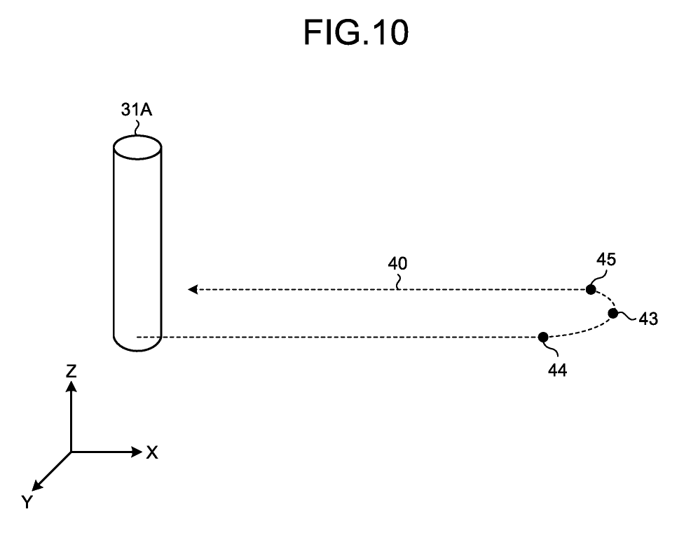

FIG. 10 is a diagram illustrating another example of change points on the tool trajectory according to the first and second embodiments of the present invention. The change point in the first and second embodiments of the present invention may be, instead of the start point and end point of each of the tool movement commands that constitute the tool trajectory, a point 43 that is an intermediate point of an arc movement command and at which a translational axis is reversed across quadrants; a point 44 at which the shape of the tool trajectory changes from a line to an arc; or a point 45 at which the shape of the tool trajectory changes from an arc to a line as illustrated in FIG. 10.

The configurations described in the foregoing embodiments are merely examples of aspects of the present invention. These configurations may be combined with other known technologies, and moreover, part of such configurations may be omitted or modified without departing from the spirit of the present invention.

### REFERENCE SIGNS LIST

1 workpiece shape processing unit; 2 workpiece shape display unit; 3 tool shape display unit; 4 display image combining unit; 5 display update unit; 5a execution command; 10 machining program data; 11 workpiece shape data; 12 projection display parameter; 13 workpiece display image data; 14 tool shape data; 15 tool display image data; 16 combined display image data; 17 tool intermediate point data; 21 mount; 22 saddle; 23 work table; 24 column; 25 ram; 26x x-axis driving mechanism; 26y y-axis driving mechanism; 26z z-axis driving mechanism; 27x x-axis motor; 27y y-axis motor; 27z z-axis motor; 26x, 28y, 28z feed shaft; 29x, 29y, 29z rotation-angle detector; 30 spindle; 31 tool; 31A tool shape image; 40 tool trajectory; 41 first intermediate point; 42 second intermediate point; 43 point that is an intermediate point of an arc movement command and at which a translational axis is reversed across quadrants; 44 point at which the shape of the tool trajectory changes from line to arc; 45 point at which the tool trajectory changes from arc to line; 51 control unit; 52 storage unit; 60 display unit; 61 memory; 62 processor; 63 input/output, unit; 100 machining simulation display apparatus; 200 machine tool; 300 workpiece; 300A workpiece shape image; 400 display screen.

1. A machining simulation display apparatus that displays, on a display screen, an image of a shape of a workpiece and a shape of a tool that machines the workpiece and that displays an animation of a process of machining the workpiece and a process of moving the tool, the apparatus comprising:
display update circuitry to provide a command to combine, at a change point on a trajectory of the tool, an image of the shape of the tool displayed on the display screen and an image of the shape of the workpiece, the change point being present between a first display update timing at which the image displayed on the display screen is updated and a second display update timing that is a time point after a lapse of a constant display update interval since the first display update timing,.
wherein the image displayed on the display screen includes an image of the shape of the workpiece and an image of the shape of the tool at the change point.

2. The machining simulation display apparatus according to claim 1, wherein the change point is a position at which a translational axis or a rotational axis of the machine tool is reversed.

3. The machining simulation display apparatus according to claim 1, wherein the change point is a position at which a shape of the trajectory of the tool changes.

4. The machining simulation display apparatus according to claim 1, wherein the display update circuitry combines an image of the shape of the workpiece updated at the second display update timing and an image of the shape of the tool updated.

5. The machining simulation display apparatus according to claim 1, wherein the display update circuitry combines an image of the shape of the workpiece updated at the first display update timing and an image of the shape of the tool updated at the change point.

6. A machining simulation display method performed by a machining simulation display apparatus that displays, on a display screen, an image of a shape of a workpiece and a shape of a tool that machines the workpiece and that displays an animation of a process of machining the workpiece and a process of moving the tool, the method comprising:
determining a change point on a trajectory of the tool between a first display update timing at which the image displayed on the display screen is updated and a second display update timing that is a time point after a lapse of a constant display update interval since the first display update timing;
combining an image of the shape of the workpiece updated at the first display update timing and an image of the shape of the tool updated at the change point and displaying a combined image on the display screen; and
combining an image of the shape of the workpiece updated at the second display update timing and an image of the shape of the tool updated at the second display update timing and displaying a combined image on the display screen.

7. The machining simulation display apparatus according to claim 2, wherein the change point is a position at which a shape of the trajectory of the tool changes.

8. The machining simulation display apparatus according to claim 2, wherein the display updater combines an image of the shape of the workpiece updated at the second display update timing and an image of the shape of the tool updated at the change point.

9. The machining simulation display apparatus according to claim 3, wherein the display updater combines an image of the shape of the workpiece updated at the second display update timing and an image of the shape of the tool updated at the change point.

10. The machining simulation display apparatus according to claim 7, wherein the display updater combines an image of the shape of the workpiece updated at the second display update timing and an image of the shape of the tool updated at the change point.

11. The machining simulation display apparatus according to claim 2, wherein the display updater combines an image of the shape of the workpiece updated at the first display update timing and an image of the shape of the tool updated at the change point.

12. The machining simulation display apparatus according to claim 3, wherein the display updater combines an image of the shape of the workpiece updated at the first display update timing and an image of the shape of the tool updated at the change point.

13. The machining simulation display apparatus according to claim 7, wherein the display updater combines an image of the shape of the workpiece updated at the first display update timing and an image of the shape of the tool updated at the change point.
